(19) United States
(12) Patent Application Publication
(10) Pub. No.: US 2008/0129466 A1
(43) Pub. Date: Jun. 5, 2008

(54) MATCHING SYSTEM AND METHOD FOR PREVENTING THE LOSS OF DATA BETWEEN LOW-POWER NETWORK AND NON-LOW-POWER NETWORK

(76) Inventors: Jae-Hong Ruy, Daejon (KR); Bong-Soo Kim, Daejon (KR); Cheol-Sig Pyo, Daejon (KR)

Correspondence Address: LADAS & PARRY LLP, 224 SOUTH MICHIGAN AVENUE, SUITE 1600, CHICAGO, IL, 60604, US

(21) Appl. No.: 11/877,784

(22) Filed: Oct. 24, 2007

(30) Foreign Application Priority Data
Nov. 30, 2006 (KR) 10-2006-0119874

(51) Int. Cl. G08B 1/08

(52) U.S. Cl. 340/286.02

(57) ABSTRACT

There is provided a matching system for preventing the loss of data between a low-power network and a non-low-power network, the matching system including: an RF communication schedule management unit, installed in the low-power network side system, for managing a schedule of an RF communication period indicative of a data transmission period of the low-power network; a heterogeneous network communication schedule management unit, disposed in the non-low-power network side system, for creating a schedule to transmit data to the low-power network side system based on the RF communication period provided by the RF communication schedule management unit; and a heterogeneous network communication unit for transmitting the data to the low-power network side system depending on the schedule created by the heterogeneous network communication schedule management unit.

### CROSS-REFERENCE TO RELATED APPLICATIONS

The present invention claims priority of Korean Patent Application No. 10-2006-0119874, filed on Nov. 30, 2006, which is incorporated herein by reference.

### BACKGROUND OF THE INVENTION

1. Field of the Invention

The present invention relates to a matching system and method for preventing the loss of data between a low-power network and a non-low-power network; and, more particularly, to a matching system and method which allow the Internet that is the non-low-power network to transmit data depending on a schedule of an RF (radio frequency) communication period of a sensor network that is the low-power network by confirming the RF communication period so as to prevent the loss of data between those networks.

This work was supported by the Information Technology (IT) research and development program of the Korean Ministry of Information and Communication (MIC) and/or the Korean Institute for Information Technology Advancement (IITA) [2005-S-038-02, “Development of UHF RF-ID and Ubiquitous Networking Technology”].

2. Description of Related Art

A sensor network that receives attention in recent years is a network that is established by sensors using a low power, and needs a gateway for matching with the Internet that is not affected by a power.

Meanwhile, a system for matching (“heterogeneous network matching system”) between the sensor network requiring the low power (“low-power network”) and the Internet that is not affected by a power (“non-low-power network”) performs a protocol conversion and data transmission and reception, like the gateway.

The heterogeneous network matching system decides only an interface for the heterogeneous network matching, and is operated as a system that is separated from the low-power network side and the non-low-power network side in many cases. At this time, the heterogeneous network matching system helps communicate between CPUs of the low-power side system and the non-low-power side system based on the low-power side system.

In particular, the low-power side system is made in a manner that the capacity of each CPU and that of the interface are very small and a data process technique is very simple. Since this low-power side system tends to solve all matters on a network to which the system itself belongs, it tries to maximally reduce the external interface. As such, the low-power side system processes only its own very simple algorithm but does not process others. On the other hand, the low-power side system is being changed for anyone to access and watch according to needs on the broadband network, without using limited space and resources.

For the above reasons, it is required that the low-power side system should know even the schedule of the non-low-power side system as well as its own schedule via the broadband interface. But, the low-power side system should be made in very simple components, and thus, it is difficult to add the schedule management function of the non-low-power side system. In other words, the low-power side system, in case of managing only its own RF communication schedule, can easily control such a schedule management, but increases the system load in case of managing the schedule for communicating with the non-low-power side system.

Therefore, in the heterogeneous network matching system, since the low-power side system has a difficult in managing the schedule of the non-low-power side system, it is required that the non-low-power side system acquires the RF communication schedule of the low-power side system to reduce the load of the low-power side system, thereby preventing the loss of data.

Meanwhile, in the heterogeneous network matching system, in case where the non-low-power side system (i.e., the Internet) sends data to the low-power side system (i.e., the sensor network), the non-low-power side system cannot confirm whether the low-power side system is ready or not ready to receive the data. Due to this, the conventional heterogeneous network matching system gives rise to the loss of the data sent from the non-low-power side system if the low-power side system is not yet ready to receive it.

Therefore, in the heterogeneous network matching system, there is a need that the non-low-power side system first acquires the RF communication schedule of the low-power side system, and then sends the data to the low-power side system in the state that it can accept the same.

### SUMMARY OF THE INVENTION

An embodiment of the present invention is directed to providing a matching system and method which allow the Internet that is the non-low-power network to transmit data depending on a schedule of an RF (radio frequency) communication period of a sensor network that is the low-power network by confirming the RF communication period so as to prevent the loss of data between those networks.

In accordance with an aspect of the present invention, there is provided a matching system for preventing the loss of data between a low-power network and a non-low-power network, the matching system including: an RF (radio frequency) communication schedule management unit, installed in the low-power network side system, for managing a schedule of an RF communication period indicative of a data transmission period of the low-power network; a heterogeneous network communication schedule management unit, disposed in the non-low-power network side system, for creating a schedule to transmit data to the low-power network side system based on the RF communication period provided by the RF communication schedule management unit; and a heterogeneous network communication unit for transmitting the data to the low-power network side system depending on the schedule created by the heterogeneous network communication schedule management unit.

In accordance with another aspect of the present invention, there is provided a matching method for preventing the loss of data between a low-power network and a non-low-power network, including the steps of: (a) receiving from the low-power network side system an RF communication period to transmit data to the low-power network, and creating a schedule to transmit the data to the low-power network side system; and (b) confirming the schedule when data is transmitted from the non-low-power network, and transmitting the data to the low-power network side system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a diagram illustrating a structure of one example of a low-power network and a non-low-power network to which the present invention is applied.

FIG. 2 is a diagram illustrating a heterogeneous network matching system for preventing the loss of data between a low-power network and a non-low-power network in accordance with a preferred embodiment of the present invention.

FIG. 3 is a flowchart illustrating a matching method for preventing the loss of data between the low-power network and the non-low-power network in accordance with another preferred embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. Hereinafter, preferred embodiments of the present invention will be described in detail with reference to the accompanying drawings.

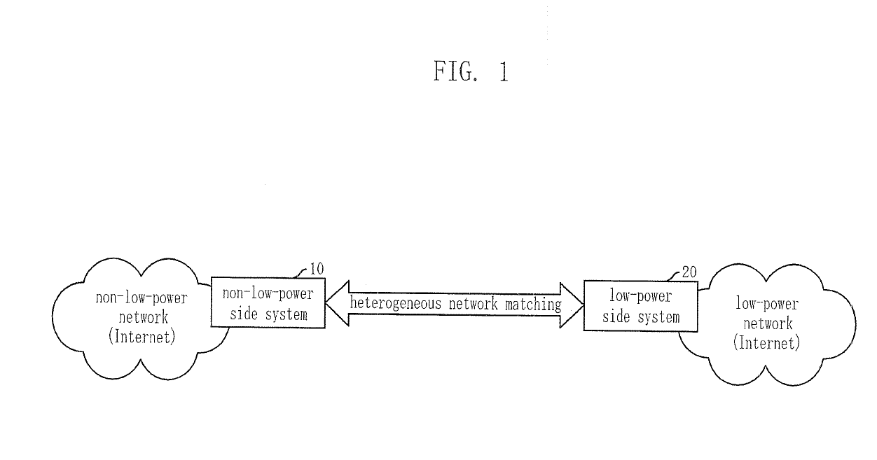

FIG. 1 is a diagram illustrating a structure of one example of a low-power network and a non-low-power network to which the present invention is applied.

As illustrated in FIG. 1, there is a non-low-power side system 10 on the non-low-power network, to which the present invention is applied, which is connected to the Internet that is a conventional high speed network.

Further, there is a low-power side system 20 on the low-power network, to which the present invention is applied. The low-power side system 20 carries out RF communication with nodes that transmit data. Namely, the low-power side system 20 and the nodes perform the RF communication depending on an RF communication period consisting of an “RF communication time” when data communication is made within a certain time and an “RF communication idle time” when the data communication is not made.

Meanwhile, when the low-power side system 20 simultaneously receives data sent from the non-low-power side system 10 and data from a node, it selects either of them due to a limit of its own process capacity. In this case, the unselected data is lost. To prevent this, the present invention is embodied in such a way that the non-low-power side system 10 confirms the RF communication period between the low-power side system 20 and the node and then sends data thereto at the “RF communication idle time”, so that the data is not lost because of mutual collision of data between the low-power network and the non-low-power network.

On the other hand, the non-low-power side system 10 can process data without any difficulty because the system resources like a CPU or memory are sufficiently kept although it simultaneously receives data sent from the low-power side system 10 and data from the non-low-power network.

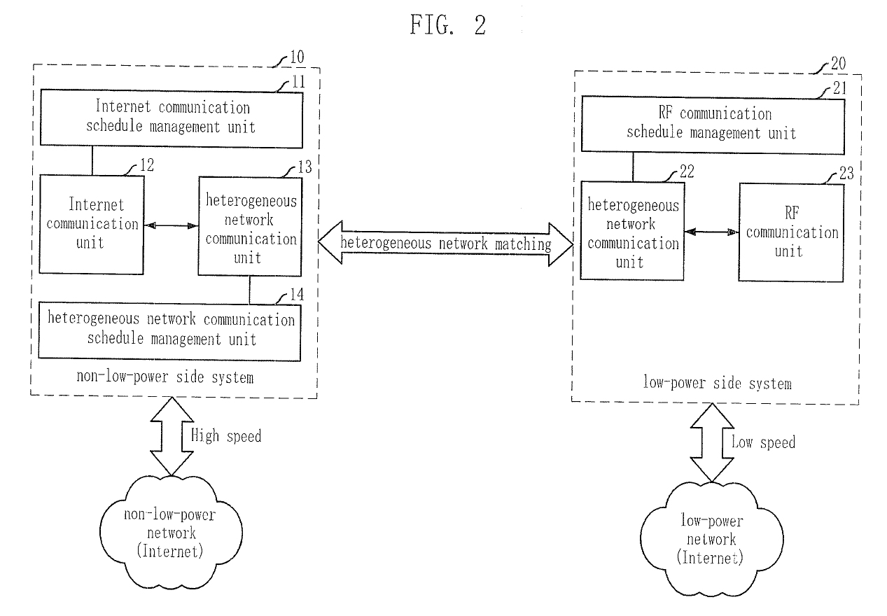

FIG. 2 is a diagram illustrating a heterogeneous network matching system for preventing the loss of data between a low-power network and a non-low-power network in accordance with a preferred embodiment of the invention.

As shown in FIG. 2, the heterogeneous network matching system of the invention includes a non-low-power side system 10 and a low-power side system 20 for connecting and matching between the non-low-power network that is a high speed network and the low-power network that is a low speed network. The non-low-power side system 10 is provided with an Internet communication schedule management unit 11, an Internet communication unit 12, a heterogeneous network communication unit 13, and a heterogeneous network communication schedule management unit 14. And the low-power side system 20 is provided with an RF communication schedule management unit 21, a heterogeneous network communication unit 22 and an RF communication unit 23.

First of all, the components of the non-low-power side system 10 will be described in detail below.

The Internet communication schedule management unit 11 manages a schedule that is used for the Internet communication unit 12 to transmit and receive data via the non-low-power network that is the high speed network.

The Internet communication unit 12 communicates with the non-low-power network based on the schedule managed by the Internet communication schedule management unit 11 by using a well-known technique. That is, the Internet communication unit 12 transfers data sent from the non-low-power network to the heterogeneous network communication unit 13, and transfers data sent from the heterogeneous network communication unit 13 to the non-low-power network.

The heterogeneous network communication unit 13 serves to perform the heterogeneous network connection for the heterogeneous network matching with the low-power side system 20. At this time, the heterogeneous network communication unit 13 communicates with the low-power side system 20 according to a schedule managed by the heterogeneous network communication schedule management unit 14. Here, the heterogeneous network communication unit 13 is connected to the heterogeneous network communication unit 22 of the low-power side system 20 through the use of a well-known technique, and therefore, details thereof are omitted here.

That is to say, when the heterogeneous network communication unit 13 would like to send data to the low-power side system 20, it sends the data to the low-power side system 20 depending on the schedule managed by the heterogeneous network communication schedule management unit 14. On the other hand, when the heterogeneous network communication unit 13 receives data transmitted from the low-power side system 20, it transfers the transmitted data to the non-low-power side network, regardless of the schedule managed by the heterogeneous network communication schedule management unit 14.

The heterogeneous network communication schedule management unit 14 gets the corresponding schedule, i.e., the RF communication period, provided from the RF communication schedule management unit 21 of the low-power side system 20. At this time, the heterogeneous network communication schedule management unit 14 manages the schedule which is necessary for the heterogeneous network communication unit 13 to transfer the data to the low-power side system 20 according to the RF communication period. Namely, the heterogeneous network communication schedule management unit 14 manages the schedule so that the heterogeneous network communication unit 13 can transfer the data in synchronism with the RF communication idle time of the low-power side system 20 by using the RF communication period.

Prior to explaining the components of the low-power side system 20, since the low-power side system 20 cannot process data sent from the non-low-power side system 10 when it is communicating with the low-power network, the data is lost. In other words, the low-power side system 20 can process the data sent from the non-low-power side system 10 only when it is under the RF communication idle.

Hereinafter, each of the components of the low-power side system 20 will be described in more detail.

First, the RF communication schedule management unit 21 manages the RF communication period that is the schedule used for the RF communication unit 23 to establish the RF communication with the low-power network that is the low speed network.

Further, the RF communication schedule management unit 21 provides the RF communication period to the heterogeneous network communication schedule management unit 14 of the non-low-power side system 10. Through this, the heterogeneous network communication schedule management unit 14 of the non-low-power side system 10 can send the data to the low-power side system 20 only when the system 20 is under the RF communication idle.

In addition, when there is a change in the RF communication period being managed by the RF communication schedule management unit 21, it sends the changed RF communication period to the heterogeneous network communication schedule management unit 14 in real-time. By doing so, the non-low-power side system 10 sends the data based on the changed RF communication period, thereby causing no loss of data.

The heterogeneous network communication unit 22 performs the heterogeneous network connection for the heterogeneous network matching with the non-low-power side system 10. At this time, the heterogeneous network communication unit 22 communicates with the non-low-power side system 10 according to the schedule managed by the RF communication schedule management unit 21. That is, the heterogeneous network communication unit 22 accepts the data sent from the non-low-power side system 10 when it is under the RF communication idle.

The RF communication unit 23 transmits and receives data to and from the low-power network that is the low speed network depending on the schedule managed by the RF communication schedule management unit 21.

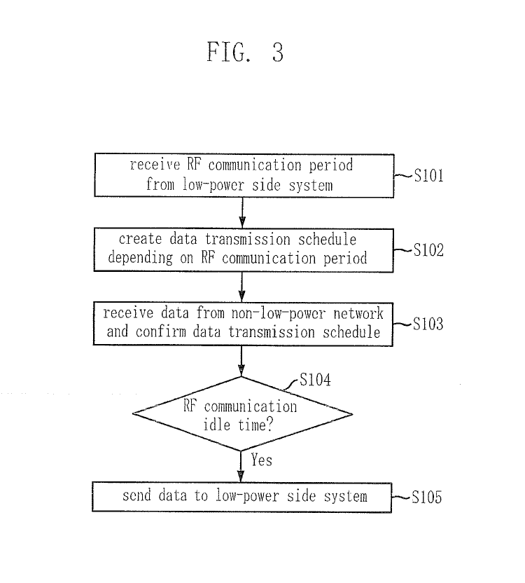

FIG. 3 is a flowchart illustrating a matching method for preventing the loss of data between the low-power network and the non-low-power network in accordance with another preferred embodiment of the invention.

As illustrated in FIG. 3, the non-low-power side system 10 receives an RF communication period from the low-power side system 20 at step S101. Then, the non-low-power side system 10 creates a transmission schedule of data to be sent to the low-power network depending on the received RF communication period at step S102. That is, the non-low-power side system 10 creates the transmission schedule so that the data is not sent to the low-power side system 20 during an RF communication time of the RF communication period, but is transmitted thereto during an RF communication idle time of the RF communication period.

Thereafter, when the non-low-power side system 10 receives the data being sent from the non-low-power network to the low-power network, it confirms the transmission schedule of the data created according to the RF communication period at step S103. At this time, the non-low-power side system 10 confirms at step S104 as to whether the low-power side system 20 is in the course of the RF communication idle time based on the schedule.

Subsequently, the non-low-power side system 10 sends the data to the low-power side system when the low-power side system 20 is in the course of the RF communication idle time at step S105.

As described above, the present invention allows the non-low-power network that is the high speed network to send the data in accordance with the RF communication period of the low-power network that is the low speed network, thus preventing the loss of data.

The method of the present invention as mentioned above may be implemented by a software program that is stored in a computer-readable storage medium such as CD-ROM, RAM, ROM, floppy disk, hard disk, optical magnetic disk, or the like. This process may be readily carried out by those skilled in the art; and therefore, details of thereof are omitted here.

While the present invention has been described with respect to the particular embodiments, it will be apparent to those skilled in the art that various changes and modifications may be made without departing from the spirit and scope of the invention as defined in the following claims.

What is claimed is:

1. A matching system for preventing the loss of data between a low-power network and a non-low-power network, the matching system comprising:
an RF (radio frequency) communication schedule management unit, installed in the low-power network side system, for managing a schedule of an RF communication period indicative of a data transmission period of the low-power network;
a heterogeneous network communication schedule management unit, disposed in the non-low-power network side system, for creating a schedule to transmit data to the low-power network side system based on the RF communication period provided by the RF communication schedule management unit; and
a heterogeneous network communication unit for transmitting the data to the low-power network side system depending on the schedule created by the heterogeneous network communication schedule management unit.

2. The matching system of claim 1, wherein the heterogeneous network communication schedule management unit creates the schedule to transmit the data to the low-power network side system when the RF communication period indicates an RF communication idle time by confirming the RF communication period provided by the RF communication schedule management unit.

3. The matching system of claim 1, wherein, when there is a change in the RF communication period being managed by the RF communication schedule management unit, the RF communication schedule management unit provides the changed RF communication period to the heterogeneous network communication schedule management unit in real-time.

4. A matching method for preventing the loss of data between a low-power network and a non-low-power network, comprising the steps of:
(a) receiving from the low-power network side system an RF communication period to transmit data to the low-power network, and creating a schedule to transmit the data to the low-power network side system; and
(b) confirming the schedule when data is transmitted from the non-low-power network, and transmitting the data to the low-power network side system.

5. The matching method of claim 4, wherein the receiving step (a) creates the schedule to transmit the data to the low-power network side system when the RF communication period indicates an RF communication idle time by confirming the RF communication period received from the low-power network side system.
